(19) United States
(12) Patent Application Publication
(10) Pub. No.: US 2004/0233805 A1
(43) Pub. Date: Nov. 25, 2004

(54) Information recording apparatus and method, information reading apparatus and method, and computer program product

(75) Inventors: Masayoshi Yoshida, Saitama (JP); Hiroki Kuribayashi, Saitama (JP); Kaoru Yamamoto, Saitama (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/793,666

(22) Filed: Mar. 5, 2004

(30) Foreign Application Priority Data
Mar. 7, 2003 (JP) 2003-061740

(51) Int. Cl. G11B 7/00

(52) U.S. Cl. 369/47.14; 369/53.17

(57) ABSTRACT

A defect on a DVD-RAM is detected by using a track error signal TE and an RF signal before the decoding thereof, which are used for the position control of an optical pickup. Because the defect detection is performed by using the track error signal TE and the RF signal before the decoding thereof, even if the verification and reproduction of information are not performed, it is possible to make or update a defect list and increase the accuracy of the defect detection. It is possible to extract only information about the defect which is the obstacle of the information recording realistically and collect it on the defect list.

### BACKGROUND OF THE INVENTION

1. Field of the Invention

The present invention relates to an information recording apparatus for and an information recording method of recording information onto a recording medium, such as an optical disc, an information reading apparatus for and an information reading method of reading the information recorded on the recording medium, and a computer program product for realizing the information recording apparatus and the information reading apparatus.

2. Description of the Related Art

In some cases, a scratch or the like is formed and fingerprints, dusts, or the like are left on the recording surface of a rewritable recording medium, such as an optical disc. Moreover, dusts or the like are possibly mixed into a recording layer in the manufacturing process of the recording medium. Furthermore, the recording medium is partially deteriorated in some cases by repeatedly rewriting information. If there are the scratch, dusts, deterioration, or the like described above (hereinafter referred to as a “defect”), it is impossible to surely record the information onto the recording medium in some cases, so that there is the possibility that the reliability of the information recording of the recording medium decreases.

In order to prevent these negative effects, there has been developed and spread a technique of surely recording the information by recording the information away from the position of a defect even if there is the defect on the recording medium. This type of technique is generally referrer to as a “defect management”. The typical examples of the conventional defect management will be described hereinafter.

For example, when a DVD-RAM is used as the recording medium to record the information, such as a computer program, image data, audio data, and text data, the DVD-RAM is formatted before the information is recorded onto the DVD-RAM in general. When formatted, the DVD-RAM is certified in general. Upon the certifying, a defect on the recording surface of the DVD-RAM or the like is detected, the position (e.g. address) of the defect on the DVD-RAM is specified, and information for indicating the position (or defect position information) is stored into a memory or the like. The detection of the defect and the collection of the defect position information are performed throughout the entire recording surface of the DVD-RAM, and a list for indicating the positions of the defects (hereinafter referred to as a “defect list”) is made. When information is recorded onto the formatted DVD-RAM, the defect list is referred to. This makes it possible to record the information away from the position of the defect on the DVD-RAM and thereby to increase the robustness of the information recording.

When information is recorded onto the DVD-RAM, the information is verified. Upon the verifying, if it is recognized that the recording is not performed normally, the information which is the object of the verification at that time is recorded into a spare area on the recording medium. At this time, moreover, it is determined that there is the defect at a position on the DVD-RAM where the information which is the object of the verification is originally supposed to be recorded. This position is recorded onto the defect list, so that the defect list is newly made or the existing defect list is updated. This makes it possible to increase the robustness of the information recording more.

Out of the examples of the conventional defect management described above, the defect detection and the making of the defect list upon the certification of the recording medium are helpful to manage an initial defect, such as the mixture of dusts or the like in the recording layer during the manufacturing process of the recording medium. On the other hand, the defect detection and the making or updating of the defect list upon the verification of the information which is already recorded (i.e., the “record information”) are helpful to manage a defect formed ex post facto by the delivery, use, or the like of the recording medium, such as a scratch and the attachment of dusts.

In the verification of the “record information”, the defect detection for making or updating the defect list is performed on the basis of the result of an error correction based on an Error-Correcting Code (ECC). Namely, when it is clarified that the error correction based on the ECC is impossible, it is determined or judged that there is a defect at a position on the recording medium where the information included in an ECC block is recorded, and the defect list is made or updated on the basis of the determination result.

However, in the method of detecting the defect on the basis of the result of the error correction, it is necessary to read the information from the recording medium, decode it, and error-correct it in order to detect the defect. As a result, the opportunity of performing the defect detection and the making or updating of the defect list is limited to the opportunity of the verification or reproduction, which is a problem. Namely, it is impossible to perform the defect detection and the making or updating of the defect list upon genuinely recording (i.e. upon only recording without any verification).

Moreover, there is a limit to increase the accuracy of the defect detection if performing it upon the verification of the “record information” only on the basis of the result of the error correction based on the ECC.

### SUMMARY OF THE INVENTION

It is therefore a first object of the present invention to provide an information recording apparatus, an information recording method, and a computer program product, in which the defect detection for making or updating the defect list can be performed upon recording the information.

It is a second object of the present invention to provide an information recording apparatus, an information reading apparatus, an information recording method, an information reading method, and a computer program, which can increase the accuracy of the defect detection.

The above object of the present invention can be achieved by an information recording apparatus provided with: an obtaining device for obtaining information; a recording device for recording the information obtained by said obtaining device onto a recording medium; a control device for controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device; a defect detecting device for detecting a defect on the recording medium on the basis of the control signal; and a list making device for making or updating a list for indicating a position of the defect from a detection result by said defect detecting device.

The above object of the present invention can be achieved by an information reading apparatus provided with: a reading device for reading information recorded on a recording medium; a decoding device for decoding the information read by said reading device; a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device; a defect detecting device for detecting a defect on the recording medium on the basis of the control signal; and a list making device for making or updating a list for indicating a position of the defect from a detection result by said defect detecting device.

The above object of the present invention can be achieved by a disc drive comprising the above-described information recording apparatus (including its various aspects).

The above object of the present invention can be achieved by a disc drive comprising the above-described information reading apparatus (including its various aspects).

The above object of the present invention can be achieved by a computer program product in a computer-readable medium for tangibly embodying a program of instructions executable by a computer to make the computer function as the above-described information recording or reading apparatus (including their various aspects).

According to the computer program product of the present invention, the above-described information recording or reading apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disc or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described information recording or reading apparatus.

The above object of the present invention can be achieved by an information recording method provided with: an obtaining process of obtaining information; a recording process of recording the information obtained by said obtaining process onto a recording medium by a recording device; a control process of controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device; a defect detecting process of detecting a defect on the recording medium on the basis of the control signal; and a list making device for making or updating a list for indicating a position of the defect from a detection result by said defect detecting process.

The above object of the present invention can be achieved by an information reading method provided with: a reading process of reading information recorded on a recording medium by a reading device; a decoding process of decoding the information read by said reading process; a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device; a defect detecting process of detecting a defect on the recording medium on the basis of the control signal; and a list making device for making or updating a list for indicating a position of the defect from a detection result by said defect detecting process.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram showing an embodiment of an information recording apparatus of the present invention;

FIG. 2 is a block diagram showing one example of a specific aspect of a defect detecting device of the information recording apparatus shown in FIG. 1;

FIG. 3 is a block diagram showing one example of a specific aspect of a defect determining device shown in FIG. 2;

FIG. 4 is an explanatory diagram showing one example of the track structure of a recording medium;

FIG. 5 is a block diagram showing an embodiment of an information reading apparatus of the present invention;

FIG. 6 is a block diagram showing the entire structure of a DVD-RAM drive apparatus associated with a first example of the present invention;

FIG. 7 is a block diagram showing the inner structure of a defect determining device in FIG. 6;

FIG. 8 is a timing chart showing the waveforms of various signals generated during the operation of the defect determining device and their time relationships;

FIG. 9 is an explanatory diagram showing one example of a defect list; and

FIG. 10 is a block diagram showing the entire structure of a DVD-RAM drive apparatus associated with a second example of the present invention.

### DETAILED DESCRIPTION OF THE PREFERRED EMBODIMENTS

The embodiments of the present invention will be explained with reference to the drawings hereinafter.

### Embodiment of Information Recording Apparatus

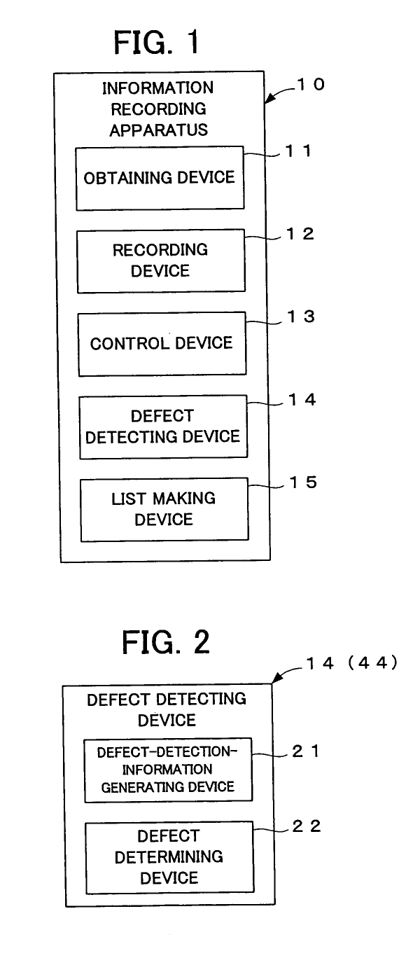

The embodiment of the information recording apparatus of the present invention will be explained with reference to FIG. 1. FIG. 1 shows the embodiment of the information recording apparatus of the present invention. Incidentally, FIG. 1 embodies constitutional elements or the like of the information recording apparatus in the embodiment of the present invention only for the purpose of explaining technical ideas thereof. The shape, size, position, connection relationship, and the like of various constitutional elements or the like are not limited to FIG. 1. The same is true for FIG. 2 to FIG. 5, which are used for the explanations of various aspects of the embodiment of the information recording apparatus of the present invention and various aspects of another embodiment of the information reading apparatus of the present invention.

An information recording apparatus 10 in FIG. 1 is an embodiment of the information recording apparatus of the present invention, and this is an apparatus for recording the information onto the recording surface of a recording medium through a recording device, such as a head, a pickup, and a probe. In general, there are various recording media, such as an optical recording medium, a magneto optical recording medium, a phase change recording medium, and a dielectric recording medium. The recording medium for the information recording apparatus 10 may be any one of the recording media described above. Nevertheless, in most cases, the useful effect by the information recording apparatus 10 is dominantly obtained with respect to the recording medium which has relatively high possibilities that a scratch is formed on the recording surface and that dusts, dirt, or the like are left thereon, i.e. the recording medium which is suspected to have a defect thereon, such as an optical disc, a magnetic disc, a magneto optical disc, a phase change disc, a dielectric disc, and a dielectric card-shaped recording medium. Moreover, the recording medium used for the information recording by the information recording apparatus 10 is capable of rewriting or recording the information. The information recorded by the information recording apparatus 10 onto the recording medium is typically a computer program, image data, audio data, text data, numeric data, control data, or the like, but not limited thereto.

As shown in FIG. 1, the information recording apparatus 10 is provided with: an obtaining device 11; a recording device 12; a control device 13; a defect detecting device 14; and a list making device 15.

The obtaining device 11 obtains the information. The obtaining device 11 may be any device if having a function of receiving the information supplied to the information recording apparatus 10 from the external equipment or the like. For example, the obtaining device 11 is typically an input/output control circuit, an interface, or the like. If receiving the information unlimitedly, the obtaining device 11 may be simply an input terminal or input line. Incidentally, if the information recording apparatus 10 integrally includes an apparatus, a circuit, or the like for generating the information, the obtaining device 11 may be a device for receiving the information from the apparatus or the circuit.

The recording device 12 records the information obtained by the obtaining device 11 onto the recording medium. The recording device 12 is, for example, a head, a pickup, a probe, or the like, and can be arbitrarily selected according to the type of the recording medium. For example, if the recording medium is an optical disc, the recording device 12 is preferably an optical pickup.

The control device 13 controls (i) the positional relationship between the recording device 12 and the recording medium and/or (ii) the recording operation of the recording device 12, on the basis of a control signal which changes according to (i) the positional relationship between the recording device 12 and the recording medium and/or (ii) the state of the recording operation of the recording device 12. When the information is to be recorded into a particular place on the recording surface of the recording medium, it is necessary to move the recording device 12 or the recording medium so that the recording device 12 is placed at a position corresponding to the particular place on the recording medium. For example, if the recording medium is the optical disc, it is necessary to place the irradiation position of the optical pickup on a particular track. On the other hand, it is necessary to set a proper clearance or moderate contact strength between the recording device 12 and the recording medium in some recording methods. For example, if the recording medium is the optical disc, it is necessary to set the clearance between the optical pickup and the optical disc (which is specifically the focal length of a lens) so that a light beam irradiated from the optical pickup focuses on the recording surface or recording layer of the optical disc. As described above, the control device 13 may control the positional relationship between the recording device 12 and the recording medium regarding the direction parallel to or perpendicular to the recording surface of the recording medium. On the other hand, in order to realize the recording of information, it is necessary to appropriately set a light, heat, magnetism, voltage, pressure, or the like which are applied by the recording device 12 to the recording medium. For example, if the recording medium is the optical disc, it is necessary to appropriately set the intensity of the light beam irradiated from the optical pickup. The control device 13 may control the recording operation of the recording device 12, such as the intensity of the light beam. The control device 13 described above can be realized by a servo control circuit, for example.

The control signal used for the control by the control device 13 changes according to (i) the positional relationship between the recording device 12 and the recording medium and/or (ii) the state of the recording operation of the recording device 12. For example, if the control device 13 is a servo control circuit for servo-controlling the positional relationship between the recording device 12 and the recording medium, this control signal is a servo control signal for servo-controlling the positional relationship between the recording device 12 and the recording medium. This servo control signal usually changes according to the positional relationship between the recording device 12 and the recording medium. More specifically, if the control device 13 is a servo control circuit for servo-controlling the positional relationship between the optical pickup and the optical disc, a Radio Frequency (RF) signal outputted from the optical pickup can be used as the control signal. A track error signal or a focus error signal may also be used as the control signal. If the control device 13 is a servo control circuit for servo-controlling the recording operation of the recording device 12, the control signal is a servo control signal for servo-controlling the recording operation of the recording device 12. This servo control signal usually changes according to the state of the recording operation of the recording device 12. More specifically, if the control device 13 is a servo control circuit for servo-controlling the intensity of the light beam irradiated from the optical pickup, the RF signal outputted from the optical pickup or the like can be used as the control signal. Particularly, the control signal preferably changes sensitively when there is a defect on the recording surface or in the recording layer of the recording medium. From such a viewpoint, it is preferable to use the RF signal, the track error signal, or the focus error signal as the control signal.

The defect detecting device 14 detects a defect on the recording medium on the basis of the control signal. For example, in case that a scratch is formed on the recording surface of the recording medium, the clearance between the recording device 12 and the recording surface of the recording medium changes according to the depth of the scratch. In case that fingerprints are left as dirt on the recording surface of the recording medium, the state of the recording operation of the recording device 12 changes. For example, in case that dirt is left on the recording surface of the optical disc, the reflectance changes which is obtained when the light beam irradiated from the optical pickup is reflected by the mirror surface of the optical disc. As a result, the presence of the defect, such as the scratch or dirt on the recording surface or in the recording layer of the recording medium, changes the control signal.

Therefore, it is possible to detect the presence of the defect on the basis of the control signal. Moreover, because the information for indicating a position where the recording device 12 is to record the information (e.g. a physical address on the recording surface) can be obtained on the basis of the positional relationship between the recording device 12 and the recording medium regarding the direction parallel to the recording surface of the recording medium, it is possible to specify the position of the defect on the recording medium by combining this positional information and the detection result of the defect. Particularly, if the recording medium is the optical disc, the amplitudes of the RF signal, the track error signal, and the focus error signal change sensitively according to the presence of the defect. Thus, by using any one of these signals as the control signal, it is possible to perform the defect detection highly accurately and specify the position of the defect accurately.

The list making device 15 makes or updates a list for indicating the positions of the defects from the detection result by the defect detecting device 14. For example, if position information (e.g. an address) for indicating the position of the defect on the recording surface can be obtained on the basis of the detection result by the defect detecting device 14, the list making device 15 stores the position information in a memory device, such as a memory. Then, the list making device 15 collects a plurality of position information of the defects obtained during the information recording by the recording device 12 and accumulates them in the memory device. This causes the making of the list of the position information for indicating the position or positions of one or a plurality of defects which exist on the recording surface or in the recording layer of the recording medium, i.e. the defect list. Incidentally, if there is the defect list, which is already made in the past, in the memory device, it is possible to rewrite or record the defect list by using the position information of the defect currently obtained, to thereby update the defect list.

The control signal, such as the RF signal, the track error signal, and the focus error signal, which changes according to (i) the positional relationship between the recording device 12 and the recording medium or (ii) the state of the recording operation of the recording device 12, is obtained while the recording device 12 is recording the information onto the recording medium. The defect is detected on the basis of this control signal, and the defect list is made or updated immediately on the basis of the detection result of the defect, so that the defect list can be made or updated upon recording the information.

As described above, according to the information recording apparatus 10, the defect list can be made or updated upon recording the information, so that it is possible to increase the making efficiency of the defect list and increasing the chance of using the defect list, as compared with a conventional information recording apparatus which cannot make the defect list except upon the verification or reproduction of information. For example, according to the information recording apparatus 10 associated with the embodiment, it can make or update the defect list while only perform the operation of recording the information continuously. After the recording is finished, the information recording apparatus 10 can confirm the recording state of a portion where a defect is present while referring to the newest defect list which has been just made. Therefore, it is possible to efficiently confirm only a place where the recording has failed highly possibly.

### Specific Aspect 1 of Embodiment of Information Recording Apparatus

A specific aspect of the embodiment of the information recording apparatus of the present invention will be explained with reference to FIG. 1 and FIG. 2. FIG. 2 shows one example of the specific aspect of the defect detecting device 14 of the information recording apparatus 10 shown in FIG. 1.

As shown in FIG. 2, the defect detecting device 14 may be provided with: a defect-detection-information generating device 21; and a defect determining device 22.

The defect-detection-information generating device 21 generates the defect detection information for indicating the presence or absence of a defect on the basis of the control signal. The defect detection information for indicating the presence or absence of a defect may be information whose content changes in response to the presence or absence of the defect, or may be a signal whose amplitude or frequency changes in response to the presence or absence of the defect.

The defect determining device 22 recognizes the extent or degree of the defect, on the basis of the defect detection information generated by the defect-detection-information generating device 21, and determines whether or not the extent of the defect is over a standard extent. For example, if the defect detection information is a signal whose amplitude varies according to the size of dusts on the recording surface of the recording medium, the defect determining device 22 can detect how large or small the variation of the amplitude of the defect detection information is and recognize the size of the defect. In this case, the defect determining device 22 can determine whether or not the size of the defect is over the standard extent by comparing the amplitude of the defect detection information actually obtained with the standard value of the amplitude set in advance.

If the defect detection information is binary information for indicating the presence or absence of a defect, the defect determining device 22 can calculate a period in which a value for indicating the presence of the defect is continuously obtained, and can estimate the size of the defect on the basis of the calculated term. If many values for indicating the presence of the defect are intermittently obtained for a short time, the defect determining device 22 can estimate that small defects are present densely in a narrow area. In this case, the defect determining device 22 can determine whether or not the extent of the defect is over the standard extent by comparing the period, in which the values for indicating the presence of the defect are continuously or intermittently obtained, with the standard value set in advance.

In this aspect, the list making device 15 records the position information for indicating the position of the defect onto the list in case that the extent of the defect is over the standard extent on the basis of the determination result by the defect determining device 22.

According to such a structure, the defect list is made or updated only if the extent of the defect is over the standard extent, so that it is possible to eliminate, from the defect list, a minor defect which does not obstruct the information recording. If small defects are densely placed in a narrow area, the position information for indicating the area where such defects are present can be recorded onto the list, so that it is possible to highly accurately detect the defects or a defect group which can become the obstacle of the information recording and it is possible to reflect it on the defect list. As described above, it is possible to collect on the defect list only the defect which highly possibly becomes the obstacle of the information recording realistically.

### Specific Aspect 2 of Embodiment of Information Recording Apparatus

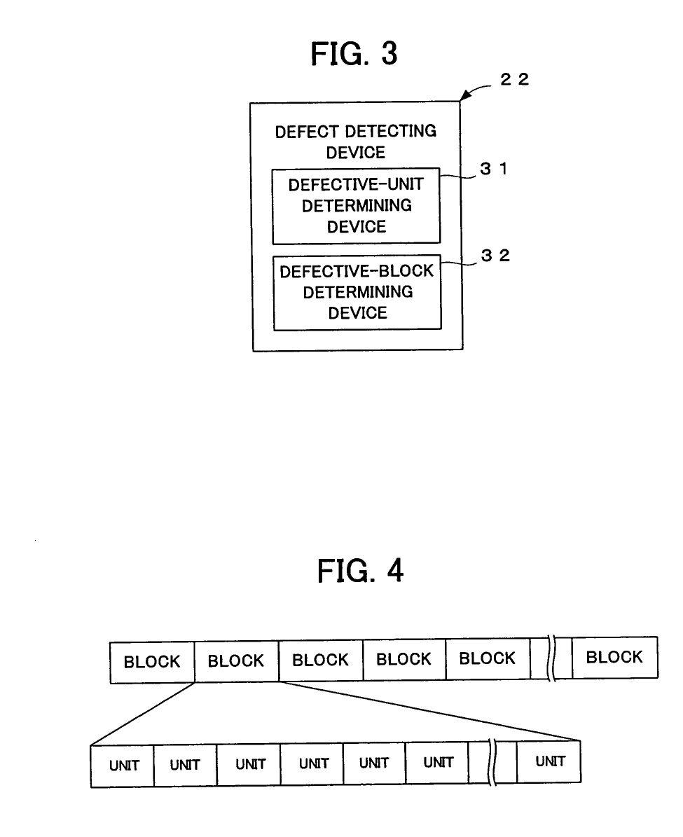

Another aspect of the embodiment of the information recording apparatus of the present invention will be explained with reference to FIG. 1 to FIG. 4. FIG. 3 shows one example of the specific aspect of the defect determining device 22 shown in FIG. 2. FIG. 4 shows one example of the track structure of the recording medium.

As shown in FIG. 3, the defect determining device 22 may be provided with: a defective-unit determining device 31; and a defective-block determining device 32. In this case, as shown in FIG. 4, a track formed on the recording surface of the recording medium is divided into a plurality of blocks, and each block is divided into a plurality of units.

The defective-unit determining device 31 determines that the unit is a defective unit if the percentage of a portion where a defect is present in one unit is over a first standard. The defective-unit determining device 31 determines whether or not each unit is the defective unit on the basis of the defect detection information generated by the defect-detection-information generating device 21. As described above, the defect detection information indicates the presence or absence of a defect on the recording surface or in the recording layer of the recording medium. If the portion where a defect is present, which is indicated by the defect detection information, is sufficiently smaller than the unit, the defective-unit determining device 31 can recognize the portion where a defect is present and the portion where there is not any defect in one unit. Thus it can recognize the percentage of the portion where a defect is present in one unit. For example, the defective-unit determining device 31 recognizes the percentage of the portion where a defect is present in one unit, compares the actually recognized percentage with the first standard set in advance, and determines that the unit is the defective unit if the percentage is over the first standard.

The defective-block determining device 32 determines that the block is a defective block if the number of the defective units in one block is over a second standard on the basis of the determination result by the defective-unit determining device 31. For example, the defective-block determining device 32 counts the number of the defective units in one block, compares this number with the second standard set in advance, and determines that the block is the defective unit when this number is over the second standard.

In this aspect, the list making device 15 records the position information for indicating the position of the defective block, onto the defect list.

According to such a structure, because only the position information of the block which has been determined to be the defective block is recorded onto the defect list, it is possible to eliminate, from the defect list, the position information of the block in which there is only a minor defect which does not obstruct the information recording. For example, if extremely small defects which do not interfere with the recording of the information are scattered on the recording surface, the percentage of the defect in one unit is not over the first standard, so that the unit is not determined to be the defective unit. If many units which do not interfere with the recording information are included in one block, the block is not determined to be the defective block. As a result, if the extremely small defects which do not interfere with the recording of information are scattered on the recording surface, the position information of the block is not recorded onto the defect list. On the other hand, if many small defects are densely placed in a narrow area on the recording surface, they highly possibly interfere with the information recording. If many small defects are densely placed in one unit, the percentage of the defect in the unit is over the first standard, so that this unit is determined to be the defective unit. If many small defects are spread and densely placed even in the units around the defective unit, the units are also determined to be the defective units. Consequently, the number of the defective units in one block is over the second standard, so that the block is determined to be the defective block. As a result, if many small defects are densely placed in the narrow area on the recording surface, the position information of the block corresponding to the area is recorded onto the defect list. Therefore, it is possible to record, on the defect list, only the block including the defect which highly possibly becomes the obstacle of the information recording realistically.

The respective sizes of the block and the unit are preferably determined from the recording unit of the “record information”, the recording density of the recording medium, the performance of the recording device 12, a unit for controlling the positional relationship between the recording device 12 and the recording medium, a unit for controlling the recording operation of the recording device 12, a unit for processing the information to be recorded onto the recording medium or the information read from the recording medium, the convenience for the encoding and decoding, or the like. For example, the block may be correlated to the “Error-Correcting Code (ECC) block”. Moreover, the unit may be correlated to the “frame”. This can increase the efficiency of the processing.

### Embodiment of Information Reading Apparatus

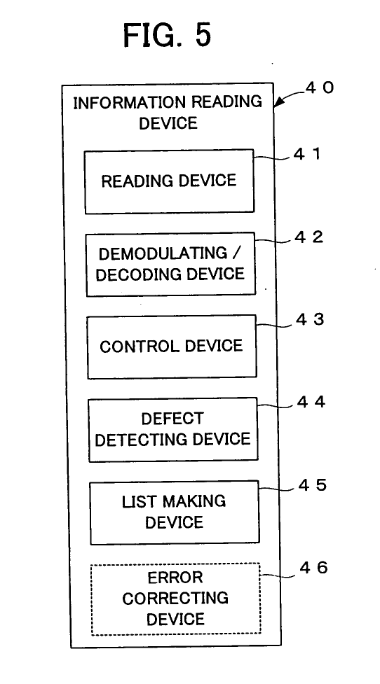

The embodiment of the information reading apparatus of the present invention will be explained with reference to FIG. 5. FIG. 5 shows the embodiment of the information reading apparatus of the present invention.

An information reading apparatus 40 in FIG. 5 is an embodiment of the information reading apparatus of the present invention, and this is an apparatus for reading the information recorded on the recording surface of the recording medium through a reading device, such as a head, a pickup, and a probe. The recording medium used by the information reading apparatus 40 may be any one of an optical recording medium, a magneto optical recording medium, a phase change recording medium, and a dielectric recording medium. Nevertheless, in most cases, the useful effect by the information reading apparatus 40 is dominantly obtained if the recording medium is used which has relatively high possibilities that a scratch is formed on the recording surface and that dusts, dirt, or the like are left thereon, i.e. the recording medium which is suspected to have a defect thereon, such as an optical disc, a magnetic disc, a magneto optical disc, a phase change disc, a dielectric disc, and a dielectric card-shaped recording medium. Moreover, the recording medium used for the information reading apparatus 40 can be any medium regardless of a memory medium for read only or a rewritable and recordable recording medium.

As shown in FIG. 5, the information reading apparatus 40 is provided with: a reading device 41; a decoding device 42; a control device 43; a defect detecting device 44; and a list making device 45.

The reading device 41 reads the information recorded on the recording medium. The reading device 42 is, for example, a head, a pickup, or a probe, and can be selected arbitrarily according to the type of the recording medium. For example, if the recording medium is an optical disc, the reading device 41 is preferably an optical pickup.

The decoding device 42 decodes the information read by the reading device 41.

The control device 43 controls (i) the positional relationship between the reading device 41 and the recording medium and/or (ii) the reading operation of the reading device 41, on the basis of a control signal which changes according to (i) the positional relationship between the reading device 41 and the recording medium and/or (ii) the state of the reading operation of the reading device 41. When information is read from a particular place on the recording surface of the recording medium, it is necessary to move the reading device 41 or the recording medium so that the reading device 41 is placed at a position corresponding to the particular place on the recording medium. For example, if the recording medium is the optical disc, it is necessary to place the irradiation position of the optical pickup on a particular track. On the other hand, it is necessary to set a proper clearance or moderate contact strength between the reading device 41 and the recording medium in some reading methods. For example, if the recording medium is the optical disc, it is necessary to set the clearance between the optical pickup and the optical disc (which is specifically the focal length of a lens) so that a light beam irradiated from the optical pickup focuses on the recording surface or recording layer of the optical disc. As described above, the control device 43 may control the positional relationship between the reading device 41 and the recording medium regarding the direction parallel to or perpendicular to the recording surface of the recording medium. On the other hand, in order to realize the reading of information, it is necessary to appropriately set a light, heat, magnetism, voltage, pressure, or the like which are applied by the reading device 41 to the recording medium. For example, if the recording medium is the optical disc, it is necessary to appropriately set the intensity of the light beam irradiated from the optical pickup. The control device 43 may control the reading operation of the reading device 41, such as the intensity of the light beam. The control device 43 described above can be realized by a servo control circuit, for example.

The control signal used for the control by the control device 43 changes according to (i) the positional relationship between the reading device 41 and the recording medium and/or (ii) the state of the reading operation of the reading device 41. For example, if the control device 43 is a servo control circuit for servo-controlling the positional relationship between the reading device 41 and the recording medium, this control signal is a servo control signal for servo-controlling the positional relationship between the reading device 41 and the recording medium. This servo control signal usually changes according to the positional relationship between the reading device 41 and the recording medium. More specifically, if the control device 43 is a servo control circuit for servo-controlling the positional relationship between the optical pickup and the optical disc, an RF signal outputted from the optical pickup can be used as the control signal. A track error signal or a focus error signal may also be used as the control signal. If the control device 43 is a servo control circuit for servo-controlling the reading operation of the reading device 41, the control signal is a servo control signal for servo-controlling the reading operation of the reading device 41. This servo control signal usually changes according to the state of the reading operation of the reading device 41. More specifically, if the control device 43 is a servo control circuit for servo-controlling the intensity of the light beam irradiated from the optical pickup, the RF signal outputted from the optical pickup or the like can be used as the control signal. Particularly, the control signal preferably changes sensitively when there is a defect on the recording surface or in the recording layer of the recording medium. From such a viewpoint, it is preferable to use the RF signal, the track error signal, or the focus error signal as the control signal.

The defect detecting device 44 detects a defect on the recording medium on the basis of the control signal. For example, in case that a scratch is formed on the recording surface of the recording medium, the clearance between the reading device 41 and the recording surface of the recording medium changes according to the depth of the scratch. In case that fingerprints are left as dirt on the recording surface of the recording medium, the state of the reading operation of the reading device 41 changes. For example, when dirt is left on the recording surface of the optical disc, the reflectance changes which is obtained when the light beam irradiated from the optical pickup is reflected by the mirror surface of the optical disc. As a result, the presence of the defect, such as the scratch or dirt on the recording surface or in the recording layer of the recording medium, changes the control signal. Therefore, it is possible to detect the presence of the defect on the basis of the control signal. Moreover, because the information for indicating a position where the reading device 41 reads information (e.g. a physical address on the recording surface) can be obtained on the basis of the positional relationship between the reading device 41 and the recording medium regarding the direction parallel to the recording surface of the recording medium, it is possible to specify the position of the defect on the recording medium by combining this positional information and the detection result of the defect. Particularly, if the recording medium is the optical disc, the amplitudes of the RF signal, the track error signal, and the focus error signal change sensitively according to the presence of the defect. Thus, by using any one of these signals as the control signal, it is possible to perform the defect detection highly accurately and specify the position of the defect accurately.

The list making device 45 makes or updates a list for indicating the positions of the defect from the detection result by the defect detecting device 44. For example, if the position information for indicating the position of the defect on the recording surface (e.g. an address) can be obtained on the basis of the detection result by the defect detecting device 44, the list making device 45 stores the position information into a memory device, such as a memory. Then, the list making device 45 collects a plurality of position information of the defect obtained during the information reading by the reading device 41 and accumulates them in the memory device. This causes the making of the list of the position information for indicating the position or positions of one or a plurality of defects which exist on the recording surface or in the recording layer of the recording medium, i.e. the defect list. Incidentally, if there is the defect list, which is already made in the past, in the memory device, it is possible to rewrite or record the defect list by using the position information of the defect currently obtained, to thereby-update the defect list.

As described above, according to the information reading apparatus 40, a defect is detected on the basis of the control signal which changes according to (i) the positional relationship between the reading device 41 and the recording medium and/or (ii) the state of the reading operation of the reading device 41, and the defect list is made on the basis of this detection result, so that it is possible to make or update the defect list extremely highly accurately. Namely, if the recording density of the recording medium is high, the positional relationship between the reading device 41 and the recording medium is controlled in extremely small units, and the state of the reading operation of the reading device 41 is also controlled in extremely small units. Thus, the positional relationship between the reading device 41 and the recording medium or (ii) the state of the reading operation of the reading device 41 is reflected in detail in the control signal for realizing the control of the positional relationship between the reading device 41 and the recording medium or (ii) the state of the reading operation of the reading device 41. As a result, even if there is an extremely small defect on the recording surface or in the recording layer of the recording medium, the control signal changes according to the presence of the defect. The defect detecting device 44 detects a defect on the basis of this type of control signal, so that it can detect the defect extremely highly accurately. The list making device 45 makes and updates the defect list on the basis of the highly accurate detection result by the defect detecting device 44, so that it can make or update the defect list extremely highly accurately. For example, it can eliminate a defect which does not interfere with the recording and reading of the information realistically, and on the other hand, it can surely recognize a defect which interferes with the recording and reading of the information realistically.

### Specific Aspect 1 of Embodiment of Information Reading Apparatus

A specific aspect of the embodiment of the information reading apparatus of the present invention will be explained with reference to FIG. 5.

As shown with a dotted line in FIG. 5, an error correcting device 46 may be added to the information reading apparatus 40. The error correcting device 46 error-corrects the information decoded by the decoding device 42, and when the error correction is incapable, it outputs the error-correction-incapable information for indicating that fact. When there is a defect on the recording surface or in the recording layer of the recording medium, the information cannot be normally recorded in the portion. Even if the information can be recorded without a problem, it cannot be read normally. If the extent of the defect is large, the information read by the reading device 41 cannot be error-corrected in some cases. When the error correction is incapable, as described above, the error correcting device 46 outputs the error-correction-incapable information for indicating that fact. The error-correction-incapable information is binary information whose value changes according to whether or not the error correction is incapable. Incidentally, the error-correction-incapable information may be information for representing the error-correction incapability using other representing methods.

In this aspect, the list making device 45 makes or updates the list on the basis of the detection result by the defect detecting device 44 and the error-correction-incapable information outputted from the error correcting device 46.

According to such a structure, it is possible to determine the presence of the defect by two types of detection processes, which are the detection process based on the control signal and the detection process based on the error correction, so that it is possible to make or update the defect list more highly accurately.

### Specific Aspect 2 of Embodiment of Information Reading Apparatus

Another aspect of the embodiment of the information reading apparatus of the present invention will be explained with reference to FIG. 2 and FIG. 5.

As with the defect detecting device 14 of the information recording apparatus 10 shown in FIG. 2, the defect detecting device 44 of the information reading apparatus 40 may be provided with: the defect-detection-information generating device 21 for generating the defect detection information for indicating the presence or absence of a defect on the basis of the control signal; and the defect determining device 22 for recognizing the extent of a defect on the basis of the defect detection information generated by the defect-detection-information generating device 21 and determining whether or not the extent of the defect is over a standard extent. In this case, the list making device 45 records the position information for indicating the position of the defect, onto the list if the extent of the defect is over the standard extent on the basis of the determination result by the defect determining device 22.

According to such a structure, the defect list is made or updated only if the extent of the defect is over the standard extent, so that it is possible to eliminate, from the defect list, a minor defect which does not obstruct the information recording and reading. If small defects are densely placed in a narrow area, the position information for indicating the area where such defects are present can be recorded onto the list, so that it is possible to highly accurately detect the defects or a defect group which can become the obstacle of the information recording and reading and to reflect it on the defect list. As described above, it is possible to collect on the defect list only the defect which highly possibly becomes the obstacle of the information recording realistically.

### Specific Aspect 3 of Embodiment of Information Reading Apparatus

Another aspect of the embodiment of the information reading apparatus of the present invention will be explained with reference to FIG. 3 to FIG. 5.

As shown in FIG. 4, a track formed on the recording surface of the recording medium may be divided into a plurality of blocks, and each block is divided into a plurality of units. As shown in FIG. 3, the defect determining device 22 may be provided with a defective-unit determining device 31 for determining that the unit is a defective unit if the percentage of a portion where a defect is present in one unit is over the first standard; and a defective-block determining device 32 for determining that the block is a defective block if the number of the defective units in one block is over a second standard on the basis of the determination result by the defective-unit determining device 31.

According to such a structure, it is possible to record, on the defect list, only the block including the defect which highly possibly becomes the obstacle of the information recording and reading realistically.

Incidentally, the block may be correlated to the “ECC block”. Moreover, the unit may be correlated to the “frame”. This can increase the efficiency of the processing.

The embodiments of the information recording apparatus or information reading apparatus described above may be realized in an integral form with hardware as an exclusive apparatus or may be realized by making a computer read a program.

### Embodiment of Information Recording Method

The embodiment of the information recording method of the present invention will be explained. The information recording method of the present invention is provided with: an obtaining process of obtaining the information; a recording process of recording the information obtained in the obtaining process onto a recording medium by a recording device; a control process of controlling (i) a positional relationship between the recording device and the recording medium and/or (ii) the recording operation of the recording device, on the basis of a control signal which changes according to (i) the positional relationship between the recording device and the recording medium and/or (ii) the state of the recording operation of the recording device; a defect detecting process of detecting a defect on the recording medium on the basis of the control signal; and a list making process of making or updating a list for indicating the position of the defect from the detection result in the defect detection process.

This information recording method is a method of recording information onto the recording surface of the recording medium through the recording device, such as a head, a pickup, and a probe. The information obtained by the obtaining process is recorded by the recording device onto the recording medium in the recording process. On the other hand, in the control process, the positional relationship between the recording device and the recording medium and/or the recording operation of the recording device is controlled on the basis of the control signal which changes according to (i) the positional relationship between the recording device and the recording medium or (ii) the state of the recording operation of the recording device. The control signal is preferably the RF signal, the track error signal, or the focus error signal if the recording medium is the optical disc, for example, as in the case of the above-described information recording apparatus 10. Because the control signal changes according to the presence of the defect, such as the scratch or dirt on the recording surface or in the recording layer of the recording medium, the presence of the defect is detected in the defect detecting process on the basis of the change of this control signal. In the list making process, the list for indicating the position of the defect is made or updated from the detection result in the defect detecting process.

The control signal, such as the RF signal, the track error signal, and the focus error signal, which changes according to (i) the positional relationship between the recording device and the recording medium or (ii) the state of the recording operation of the recording device, is obtained while the recording device is recording information onto the recording medium. The defect is detected on the basis of this control signal, and the defect list is made or updated immediately on the basis of the detection result of the defect. Therefore, the recording process, the control process, the defect detecting process, and the list making process are performed substantially simultaneously or continuously. As a result, the defect list can be made or updated upon recording the information.

As described above, according to the information recording method of the present invention, the defect list can be made or updated upon recording the information, so that it is possible to increase the making efficiency of the defect list and the chance of using the defect list, as compared with a conventional information recording method which cannot make the defect list except upon the verification or reproduction of the information.

### Embodiment of Information Reading Method

The embodiment of the information reading method of the present invention will be explained. The information reading method of the present invention is provided with: a reading process of reading the information recorded on a recording medium by a reading device; a decoding process of decoding the information read in the reading process; a control process of controlling a positional relationship between the reading device and the recording medium and/or (ii) the state of the reading operation of the reading device, on the basis of a control signal which changes according to (i) the positional relationship between the reading device and the recording medium or (ii) the state of the reading operation of the reading device; a defect detecting process of detecting a defect on the recording medium on the basis of the control signal; and a list making process of making or updating a list for indicating the position of the defect from the detection result in the defect detection process.

This information reading method is a method of reading the information recorded on the recording surface of the recording medium through the reading device, such as a head, a pickup, and a probe. The information recorded on the recording medium is read in the reading process, and this information is decoded in the decoding process. On the other hand, in the control process, (i) the positional relationship between the reading device and the recording medium and/or (ii) the reading operation of the reading device is controlled on the basis of the control signal which changes according to (i) the positional relationship between the recording device and the recording medium or (ii) the state of the recording operation of the recording device. The control signal is preferably the RF signal, the track error signal, or the focus error signal if the recording medium is the optical disc, for example, as in the case of the above-described information reading apparatus 40. Because the control signal changes according to the presence of the defect, such as the scratch or dirt on the recording surface or in the recording layer of the recording medium, the presence of the defect is detected in the defect detecting process on the basis of the change of this control signal. In the list making process, the list for indicating the position of the defect is made or updated from the detection result in the defect detecting process.

As described above, according to the information reading method of the present invention, a defect is detected on the basis of the control signal which changes according to (i) the positional relationship between the reading device and the recording medium and/or (ii) the state of the reading operation of the reading device, and the defect list is made on the basis of this detection result, so that it is possible to make or update the defect list extremely highly accurately.

### EXAMPLES

The examples of the present invention will be explained with reference to the drawings hereinafter. The examples below show that an information recording/reading apparatus including the information recording apparatus and the information reading apparatus of the present invention is applied to a DVD-RAM drive apparatus.

### First Example

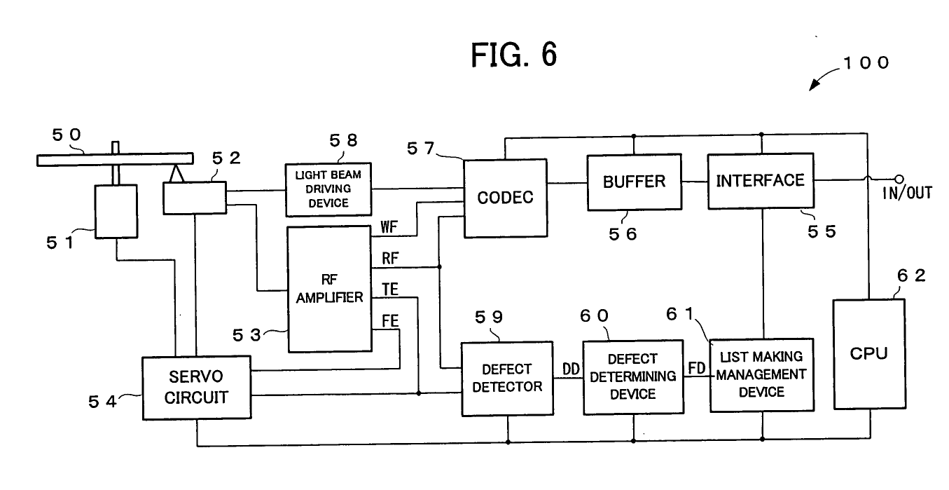

FIG. 6 shows the entire structure of a DVD-RAM drive apparatus associated with the first example of the present invention.

As shown in FIG. 6, a drive apparatus 100 in the first example of the present invention records the information onto a DVD-RAM 50 and reads the information recorded on the DVD-RAM 50.

The DVD-RAM 50 is a rewritable optical disc. The DVD-RAM 50 adopts a Wobble Land Groove method and has wobbled lands, wobbled grooves, and pre-pits, which are formed in advance, on the recording surface thereof.

As shown in FIG. 6, the drive apparatus 100 is provided with: a spindle motor 51; an optical pickup 52; an RF amplifier 53; and a servo circuit 54. These elements are intended to constitute mainly the driving mechanism of the drive apparatus 100 and its driving control device.

The spindle motor 51 is a motor for rotating the DVD-RAM 50.

The optical pickup 52 records the information onto the recording surface by irradiating a light beam onto the recording surface and reads the information recorded on the recording surface by receiving the reflected light of the light beam. The information to be recorded or already recorded by the light beam of the optical pickup 52 on the DVD-RAM 50 is referred to as the “record information” hereinafter.

The optical pickup 52 outputs an RF signal corresponding to the reflected light of the light beam upon both recording and reading. The wobbled lands and grooves as well as the pre-pits are formed in advance on the recording surface of the DVD-RAM 50, so that the RF signal includes the control signal, such as the wobble, land, group, and pre-pit. If the “record information” is already recorded on the DVD-RAM 50, this “record information” is also included in the RF signal.

The RF amplifier 53 amplifies the RF signal outputted from the optical pickup 52 and outputs it to each of a CODEC (i.e., a device mainly having functions of an encoder and a modulator upon recording as well as a demodulator and a decoder upon reading) 57 and a defect detector 59. An alphabetical reference “RF” in FIG. 6 indicates the RF signal amplified and outputted by the RF amplifier 53. Moreover, the RF amplifier 53 makes, from the RF signal, a wobble frequency signal WF, a track error signal TE, and a focus error signal FE, and outputs them.

The servo circuit 54 is a servo control circuit for controlling the driving of the optical pickup 52 and the spindle motor 51 on the basis of the track error signal TE, the focus error signal FE, and other servo control signals. Namely, the track error signal TE changes according to the positional relationship between the optical pickup 52 and the DVD-RAM 50 regarding the direction parallel to the recording surface. The servo circuit 54 controls the positional relationship between the optical pickup 52 and the DVD-RAM 50 on the basis of the track error signal TE. The focus error signal FE changes according to the state of the focusing of the light beam of the optical pickup 52. The servo circuit 54 controls the focusing of the light beam of the optical pickup 52 on the basis of the focus error signal FE.

As shown in FIG. 6, the drive apparatus 100 is provided with: an interface 55; a buffer 56; the CODEC 57; and a light beam driving device 58. These elements take mainly on the reception and encoding of the “record information” to be recorded onto the DVD-RAM 50 and on the decoding and output of the “record information” read from the DVD-RAM 50.

The interface 55 is a circuit for controlling the input/output or communication of the “record information” or the like between the drive apparatus 100 and the external equipment. Specifically, upon recording, the interface 55 receives the “record information” which is inputted to the drive apparatus 100 from the external equipment and outputs this information to the buffer 56. Moreover, upon reproducing, the interface 55 outputs the “record information” outputted from the buffer 56 (i.e. the “record information” read from the DVD-RAM 50) to the external equipment. Incidentally, the external equipment is, for example, a personal computer if the drive apparatus 100 is the personal computer. Moreover, the external equipment is, for example, a DVD recorder or the backend of a player (i.e. a portion provided with: a circuit for MPEG-compressing and decoding the audio and images; a circuit for converting the information to finally output the audio and images; or the like) if the drive apparatus 100 is included in the DVD recorder or the player.

The buffer 56 is a memory circuit for storing the “record information” temporarily.

The CODEC 57 is a circuit, provided with: a function of appending an error correction code or mark to the “record information” upon recording thereby to encode and then modulate this information; and a function of error-correcting the. “record information” upon reading. Specifically, upon recording, the CODEC 57 applies the error correction code to the “record information” outputted from the buffer 56, encodes and modulates this information to have a code (signal) suited to the optical characteristics or the like of the DVD-RAM 50, and then outputs the encoded and modulated “record information” to the light beam driving device 58. On the other hand, upon reading, the CODEC 57 demodulates and then decodes the RF signal outputted from the RF amplifier 53 upon reading, error-corrects the decoded RF signal, and then outputs this to the buffer 56.

Upon recording, the light beam driving device 58 generates a light beam driving signal corresponding to the “record information” outputted from the CODEC 57 and outputs this signal to the optical pickup 52. The optical pickup 52 modulates a light beam on the basis of the light beam driving signal and irradiates it onto the recording surface of the DVD-RAM 50. This causes the recording of the “record information” or the like onto the recording surface.

As shown in FIG. 6, the drive apparatus 100 is provided with: the defect detector 59; a defect determining device 60; and a list making management device 61. These elements mainly detect a defect on the recording surface or in the recording layer of the DVD-RAM 50, and make or update the defect list on the basis of the detection result.

The defect is a scratch formed on the recording surface or in the recording layer of the DVD-RAM 50, or dusts and dirt left on these places, or the like. When the “record information” is repeatedly recorded in the same place of the DVD-RAM 50, the place is deteriorated and a recording function thereon is decreased in some cases. Such deterioration is also included in the defect.

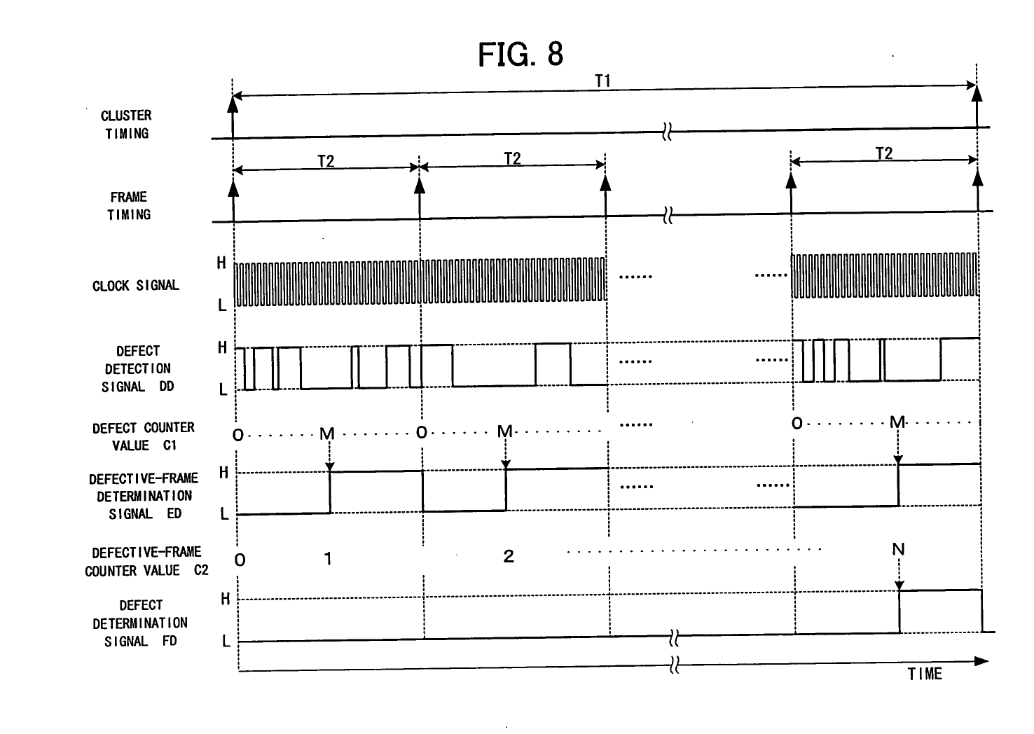

The defect detector 59 is a circuit for detecting a defect on the DVD-RAM 50 on the basis of the RF signal and the track error signal TE. The defect detector 59 generates a defect detection signal DD for indicating the presence or absence of a defect and outputs this signal. For example, when there is a defect on the recording surface of the DVD-RAM 50, the waveform of the RF signal or the track error signal TE changes to a different waveform from the normal (i.e, usual) one. The defect detector 59 monitors the waveforms of the RF signal and the track error signal and makes the defect detection signal DD high-level when they are the normal waveforms. On the other hand, the defect detector 59 makes the defect detection signal DD low-level when they are different from the normal waveforms. As a result, the defect detection signal DD is high-level if there is not any defect on the recording surface of the DVD-RAM 50, and it is low-level if there is a defect (refer to FIG. 8).

The RF signal corresponds to the reflected light of a light beam. Therefore, the change in the intensity of the reflected light inputted to the light-receiving element of the optical pickup 52 is reflected in the RF signal substantially as it is. Thus, if there is a defect on the recording surface or in the recording layer of the DVD-RAM 50, its presence is reflected in the RF signal highly accurately. For example, even if there are an extremely small defect, the presence of the defect causes the waveform of the RF signal to be different from the normal or usual one. The same is true for the track error signal TE. Therefore, the defect detection signal DD reflects the presence of a defect highly accurately and faithfully. Even in case that extremely small defects are scattered on the recording surface, the signal level of the defect detection signal DD changes sensitively according to the presence of the defect.

The defect determining device 60 recognizes the extent of a defect on the basis of the defect detection information DD outputted from the defect detector 59 and determines whether or not the extent of the defect is over a standard extent. If the extent of the defect is over the standard extent, the defect determining device 60 outputs a defect determination signal FD for indicating that fact to the list making management device 61. The defect determining device 60 will be described in detail later.

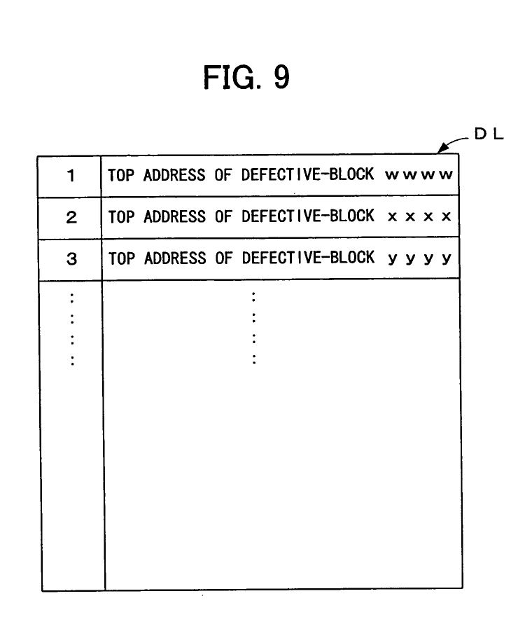

The list making management device 61 is a circuit for making or updating a defect list DL on the basis of the defect determination signal FD outputted from the defect determining device 60. As shown in FIG. 9, the defect list DL is a list in which the position information for indicating the position of a defect on the recording surface is recorded. The defect list DL is stored rewritably into a memory circuit in the list making management device 61. The list making management device 61 will be described in detail later.

Moreover, as shown in FIG. 6, the drive apparatus 100 is equipped with a Central Processing Unit (CPU) 62. The CPU 62 controls the drive apparatus 100 as a whole, and controls and manages the exchange of the information among the elements in the drive apparatus 100 described above.

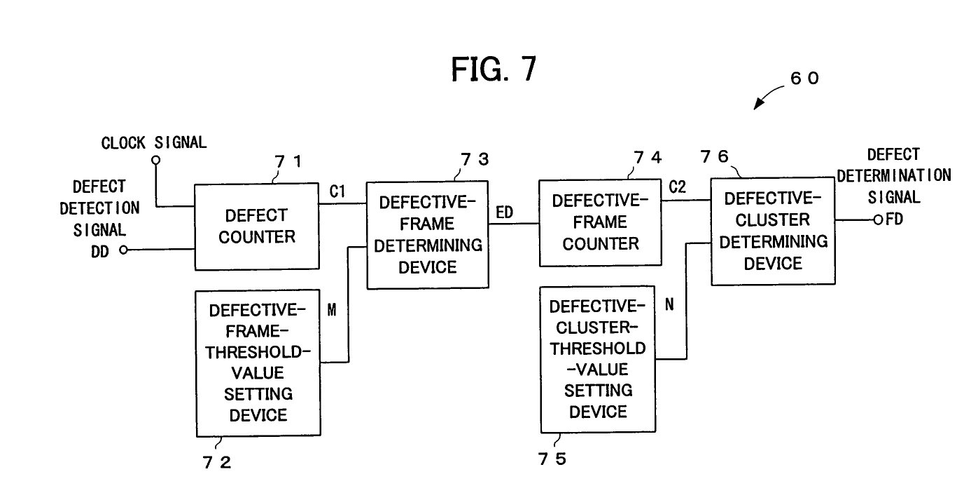

FIG. 7 shows the inner structure of the defect determining device 60. FIG. 8 shows the waveforms of various signals generated during the operation of the defect determining device 60. With reference to FIG. 7 and FIG. 8, the function and structure of the defect determining device 60, the detection and determination of a defect, and the making or updating of the defect list will be explained hereinafter.

As described above, the defect determining device 60 is a circuit for recognizing the extent of a defect on the basis of the defect detection information DD outputted from the defect detector 59 and determining whether or not the extent of the defect is over the standard extent. The defect determining device 60 determines whether or not the extent of a defect is over the standard extent, basically in the following method.

The defect determining device 60 determines the extent of a defect on the basis of two units, which are a “frame” and a “cluster”. The cluster indicates one divided portion in the case where the RF signal (“record information”) read from the DVD-RAM 50 is divided by a first length. The frame indicates one divided portion in the case where one cluster is further divided by a second length. In general, the recording and reading of the “record information” on a DVD-RAM is performed in units of frames. Also, the error-code application and the error correction of the “record information” on a DVD-RAM is performed in units of clusters (ECC blocks). The defect determining device 60 determines the extent of a defect on the basis of the frame, which is a unit of the recording and reading of the “record information” on the DVD-RAM 50, and the cluster, which is a unit of the error-code application and the error correction of the “record information” on the DVD-RAM 50.

Specifically explaining, the defect determining device 60 detects the percentage of a portion where a defect is present in one frame, and determines that the frame is a defective frame if the percentage is over a threshold value M. The defect determining device 60 performs such a determination to all frames belonging to one cluster. Moreover, the defect determining device 60 counts the number of the defective frames included in the one cluster, and determines that the cluster is a defective cluster if the number is over a threshold value N. As described above, when the extent of a defect in the one cluster is over the standard extent determined from the threshold values M and N, it is determined that the cluster is a defective cluster.

The defect determining device 60 performs the predetermined defect determination with respect to the frame and the cluster as described above, at the same time of the recording of the “record information” upon recording and at the same time of the reading of the “record information” upon reading. Namely, while the recording and the reading are being performed, the defect determining device 60 performs the above-described predetermined defect determination to one or a plurality of clusters which are the object of the processing.

The above-described predetermined defect determination of the defect determining device 60 is realized by a specific circuit shown in FIG. 7.

As shown in FIG. 7, the defect determining device 60 is provided with: a defect counter 71; a defective-frame-threshold-value setting device 72; a defective-frame determining device 73; a defective-frame counter 74; a defective-cluster-threshold-value setting device 75; and a defective-cluster determining device 76.

The defect counter 71 is a counter for counting the sum of periods in which the defect detection signal DD is low-level in one frame. As described above, the defect detection signal DD is high-level when there is not any defect on the recording surface of the DVD-RAM 50, and it is low-level when there is a defect. Therefore, if the sum of the periods in which the defect detection signal DD is low-level in one frame and the period of one frame as a whole can be recognized, it is possible to learn the percentage of the portion where a defect is present in one frame on the basis of the ratio of them. The defect counter 71 receives the defect detection signal DD and a clock signal, as shown in FIG. 7, counts the sum of the periods in which the defect detection signal DD on the basis of the clock signal, as shown in FIG. 8, and outputs a counter value C1, which is the counting result. The clock signal is supplied from a clock oscillator (not-illustrated) placed in the drive apparatus 100. The defect counter 71 resets the counter value C1 to zero every time the frame changes.

The defective-frame-threshold-value setting device 72 is a circuit for storing the threshold value M and outputting the threshold value M if needed.

The defective-frame determining device 73 is a circuit for determining whether or not the sum of the periods in which the defect detection signal DD is low-level in one frame is over the threshold value M. When the sum of the periods in which the defect detection signal DD is low-level in one frame is over the threshold value M, the defective-frame determining device 73 generates a defective-frame determination signal ED for indicating that and outputs this signal. Namely, the defective-frame determining device 73 is intended to realize a function of determining whether or not the one frame is a defective frame. More specifically, as shown in FIG. 7, the defective-frame determining device 73 receives the counter value C1 and the threshold value M and compares the both values mutually. Then, as shown in FIG. 8, the defective-frame determining device 73 makes the defective-frame determination signal ED high-level if the counter value C1 is over the threshold value M. On the other hand, the defective-frame determining device 73 makes the defective-frame determination signal ED low-level if the counter value C1 is not over the threshold value M. The defective-frame determining device 73 makes the defective-frame determination signal ED low-level every time the frame changes.

The defective-frame counter 74 is a counter for counting the number of the defective frames in one cluster. Specifically, as shown in FIG. 7, the defective-frame counter 74 receives the defective-frame determination signal ED, counts the number of times the defective-frame determination signal ED changes from the low-level to the high-level, and outputs a counter value C2 thereof.

The defective-cluster-threshold-value setting device 75 is a circuit for storing the threshold value N and outputting the threshold value N if needed.

The defective-cluster determining device 76 is a circuit for determining whether or not the number of the defective frames in one cluster is over the threshold value N. If the number of the defective frames in one cluster is over the threshold value N, the defective-cluster determining device 76 generates the defect determination signal FD for indicating that and outputs this signal. Namely, the defective-cluster determining device 76 is intended to realize a function of determining whether or not the one cluster is a defective cluster. More specifically, as shown in FIG. 7, the defective-cluster determining device 76 receives the counter value C2 and the threshold value N and compares the both values mutually. Then, as shown in FIG. 8, the defective-cluster determining device 76 makes the defect determination signal FD high-level if the counter value C2 is over the threshold value N. On the other hand, the defective-cluster determining device 76 makes the defect determination signal FD low-level if the counter value C2 is not over the threshold value N. The defective-cluster determining device 76 makes the defect determination signal FD low-level every time the cluster changes.

The defect determination signal FD is outputted from the defective-cluster determining device 76 to the list making management device 61. When the defect determination signal FD becomes high-level, the list making management device 61 obtains the position information about the cluster which is the object of the defect detection and determination at that time point, and records it onto the defect list. Namely, as shown in FIG. 9, the position information of the defective cluster (e.g. a physical address on the recording surface corresponding to the beginning of the cluster) is recorded onto the defect list DL. The “xxxx”, “yyyy”, or the like on the defect list DL shown in FIG. 9 is a physical address on the recording surface on the recording surface corresponding to the beginning of the cluster.

In general, the physical address on the recording surface of a DVD-RAM can be obtained on the basis of pre-pits formed in advance on the recording surface. The drive apparatus 100 reads the pre-pits of the DVD-RAM 50 upon recording and reading, and the CPU 62 or the like recognizes that. Therefore, the list making management device 61 can obtain the position information of the cluster from the CPU 62 or the like if needed.

The entire operation of the drive apparatus 100 upon recording will be explained hereinafter. When the “record information” supplied from the external equipment to the drive apparatus 100 is recorded onto the DVD-RAM 50, the “record information” supplied from the external equipment is supplied through the interface 55 and the buffer 56 to the CODEC 57. Then, the error correction code is appended to the “record information” and it is encoded and modulated by the CODEC 57 and the light beam driving device 58. Then it is supplied to the optical pickup 52. Thus, a light beam modulated on the basis of the “record information” is irradiated onto the recording surface of the DVD-RAM 50, and pits corresponding to the “record information” is formed on the recording surface. At this time, the reflected light of the light beam is inputted to the light-receiving element of the optical pickup 52 and supplied to the RF amplifier 53 in the form of the RF signal. The RF signal amplified by the RF amplifier 53 and the track error signal TE generated by the RF amplifier 53 are supplied to the defect detector 59. The defect detector 59 and the defect determining device 60 detect and determine a defect on the basis of the RF signal and the track error signal TE, thereby to detect the defective cluster. The list making management device 61 records the position information of the defective cluster onto the defect list DL.

Next, the entire operation of the drive apparatus 100 upon reading will be explained. When the “record information” recorded on the DVD-RAM 50 is read and outputted to the external equipment, the “record information” recorded on the DVD-RAM 50 is read by the optical pickup 52, amplified by the RF amplifier 53 in the form of the RF signal, and supplied to the CODEC 57. Then, the RF signal is demodulated and decoded, error-corrected, and outputted by the CODEC 57 through the buffer 56 and the interface 55 to the external equipment. At this time, the RF signal amplified by the RF amplifier 53 and the track error signal TE generated by the RF amplifier 53 are supplied to the defect detector 59. The defect detector 59 and the defect determining device 60 detect and determine a defect. The list making management device 61 makes and updates the defect list DL.

The defect list DL made or updated upon recording or reproducing is recorded into a predetermined area on the DVD-RAM 50 in the middle of or after the recording or reproducing. The defect list DL recorded on the DVD-RAM 50 is used for the next recording. For example, in the next recording, the defect list DL recorded on the DVD-RAM 50 is read and the position information of the defective cluster recorded on the defect list DL is referred to. Then, on the basis of the position information of the defective cluster, the “record information” is recorded away from an area on the recording surface corresponding to the defective cluster.

As described above, according to the drive apparatus 100, a defect is detected and determined on the basis of the RF signal before the decoding thereof and the track error signal TE, so that it is possible to make or update the defect list DL not only upon reading the “record information” but also upon recording it. Therefore, it is possible to increase the making efficiency of the defect list DL and the chance of using the defect list DL. For example, the defect list DL is usually used for the next recording, but it is also possible to use this immediately after the current recording and thereby to confirm the recording state. More specifically, it is possible to only record the “record information” continuously (i.e. to record it without repeating the recording and the verifying alternately), make or update the defect list DL, and confirm, after the recording, the recording state in the area on the recording surface corresponding to the defective cluster while referring to the newest defect list DL which has just made. This makes it possible to efficiently confirm only a place where the recording has failed highly possibly.

Moreover, according to the drive apparatus 100, a defect is detected on the basis of the RF signal before the decoding thereof and the track error signal TE, so that it is possible to realize the highly accurate defect detection.

Furthermore, according to the drive apparatus 100, firstly, on the basis of the result of the highly accurate defect detection, the defective frame is determined by counting the percentage of a portion where a defect is present in one frame. Then, the defective cluster is determined by counting the number of the defective frames in one cluster, and only the position information of the defective cluster is recorded onto the defect list DL. Thus, it is possible to accurately extract only the defect which highly possibly becomes the obstacle of the information recording realistically and collect it on the defect list DL. For example, if extremely small defects are scattered on the recording surface, the possibility that they become the obstacle of the information recording is low, so that such defects can be ignored. Moreover, if many small defects are densely placed in a narrow area, the possibility that they become the obstacle of the information recording is high, so that the area where such defects are present is recorded on the defect list DL as the defective cluster.

### Second Example

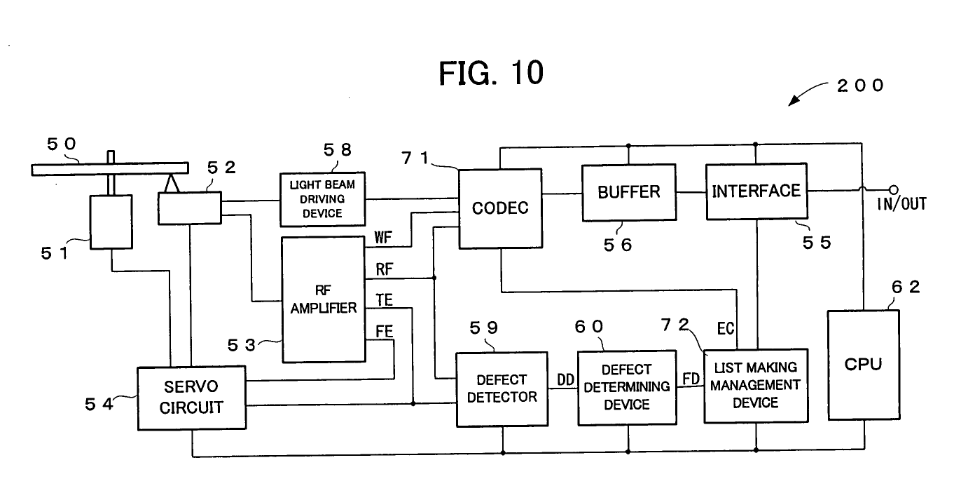

FIG. 10 shows the entire structure of a DVD-RAM drive apparatus associated with the second example of the present invention.

As shown in FIG. 10, the structure of a drive apparatus 200 in the second example of the present invention is the same as that of the drive apparatus 100, except an encoder/decoder (CODEC) 71 and a list making management device 72.

As with the CODEC 57, the CODEC 71 is provided with: a function of appending an error correction code or mark to the “record information” upon recording thereby to encode and modulate this information; and a function of error-correcting the “record information” upon reading. Moreover, when the error correction is incapable after error-correcting the decoded RF signal, the CODEC 71 generates an error-correction-incapable signal EC for substantially indicating that fact and outputs this signal to the list making management device 72.

The list making management device 72 makes or updates the defect list DL on the basis of the defect determination signal FD outputted from the defect determining device 60 and the error-correction-incapable signal EC outputted from the CODEC 71.

As described above, according to the drive apparatus 200, the defect list DL is made or updated on the basis of the two results, which are the result of the defect detection and determination based on the RF signal and the track error signal TE and the result of the error correction. Thus, it is possible to realize the making or updating of the defect list which is more highly accurate and which is more appropriate for practical use.

Incidentally, in the examples described above, a defect is detected and determined by using the RF signal and the track error signal TE, but only the RF signal or only the track error signal TE may be used for the defect detection and determination. Moreover, other control signals, such as the focus error signal FE and the wobble frequency signal WF, may be also used for the defect detection and determination.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-061740 filed on Mar. 7, 2003 including the specification, claims, drawings and summary is incorporated herein by reference in its entirety.

What is claimed is:

1. An information recording apparatus comprising:
an obtaining device for obtaining information;
a recording device for recording the information obtained by said obtaining device onto a recording medium;
a control device for controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device;
a defect detecting device for detecting a defect on the recording medium on the basis of the control signal; and
a list making device for making or updating a list for indicating a position of the defect from a detection result by said defect detecting device.

2. The information recording apparatus according to claim 1, wherein
said defect detecting device comprises:
a defect-detection-information generating device for generating defect-detection-information for indicating presence or absence of the defect on the basis of the control signal; and
a defect determining device for recognizing an extent of the defect on the basis of the defect-detection-information generated by said defect-detection-information generating device and determining whether or not the recognized extent of the defect is over a standard extent, and
said list making device records, onto the list, position information for indicating the position of the defect if the recognized extent of the defect is over the standard extent on the basis of a determination result by said defect determining device.

3. The information recording apparatus according to claim 2, wherein
a track formed on a recording surface of the recording medium is divided into a plurality of blocks, each of the plurality of blocks being further divided into a plurality of units,
said defect determining device comprises:
a defective-unit determining device for determining that one unit of the units is a defective unit if a percentage of a portion where the defect is present in said one unit is over a first standard; and
a defective-block determining device for determining that one block of the blocks is a defective block if the number of the defective units in said one block is over a second standard on the basis of a determination result by said defective-unit determining device, and
said list making device records, onto the list, position information for indicating a position of the defective block.

4. The information recording apparatus according to claim 1, wherein said list making device makes or updates the list while said recording device is recording the information onto the recording medium.

5. The information recording apparatus according to claim 1, wherein the recording medium is an optical disc.

6. The information recording apparatus according to claim 1, wherein said recording device is an optical pickup.

7. The information recording apparatus according to claim 1, wherein the control signal is a servo control signal for servo-controlling (i) the positional relationship between said recording device and the recording medium or (ii) the recording operation of said recording device.

8. The information recording apparatus according to claim 6, wherein the control signal is a Radio Frequency (RF) signal outputted from the optical pickup.

9. The information recording apparatus according to claim 1, wherein the control signal is a track error signal.

10. The information recording apparatus according to claim 3, wherein the block corresponds to an Error-Correcting Code (ECC) block.

11. The information recording apparatus according to claim 3, wherein the block corresponds to a frame.

12. The information recording apparatus according to claim 1, wherein the defect is a scratch, dirt, or dusts on or in the recording medium.

13. An information reading apparatus comprising:
a reading device for reading information recorded on a recording medium;
a decoding device for decoding the information read by said reading device;
a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device;
a defect detecting device for detecting a defect on the recording medium on the basis of the control signal; and
a list making device for making or updating a list for indicating a position of the defect from a detection result by said defect detecting device.

14. The information reading apparatus according to claim 13, comprising: an error correcting device for (i) error-correcting the information decoded by said decoding device and (ii) outputting error-correction-incapable information for substantially indicating that the error correction is incapable if the error correction is incapable, wherein
said list making device makes or updates the list on the basis of the detection result by said defect detecting device and the error-correction-incapable information outputted from said error-correcting device.

15. The information reading apparatus according to claim 13, wherein
said defect detecting device comprises:
a defect-detection-information generating device for generating defect-detection-information for indicating presence or absence of the defect on the basis of the control signal; and
a defect determining device for recognizing an extent of the defect on the basis of the defect detection information generated by said defect-detection-information generating device and determining whether or not the recognized extent of the defect is over a standard extent, and
said list making device records, onto the list, position information for indicating the position of the defect if the recognized extent of the defect is over the standard extent on the basis of a determination result by said defect determining device.

16. The information reading apparatus according to claim 15, wherein
a track formed on a recording surface of the recording medium is divided into a plurality of blocks, each of the plurality of blocks being further divided into a plurality of units,
said defect determining device comprises:
a defective-unit determining device for determining that one unit of the units is a defective unit if a percentage of a portion where the defect is present in said one unit is over a first standard; and
a defective-block determining device for determining that one block of the blocks is a defective block if the number of the defective units in said one block is over a second standard on the basis of a determination result by said defective-unit determining device, and
said list making device records, onto the list, position information for indicating a position of the defective block.

17. The information reading apparatus according to claim 13, wherein the recording medium is an optical disc.

18. The information reading apparatus according to claim 13, wherein said reading device is an optical pickup.

19. The information reading apparatus according to claim 13, wherein the control signal is a servo control signal for servo-controlling (i) the positional relationship between said reading device and the recording medium or (ii) the reading operation of said reading device.

20. The information reading apparatus according to claim 18, wherein the control signal is a Radio Frequency (RF) signal outputted from the optical pickup.

21. The information reading apparatus according to claim 13, wherein the control signal is a track error signal.

22. The information recording apparatus according to claim 16, wherein the block corresponds to an Error-Correcting Code (ECC) block.

23. The information recording apparatus according to claim 16, wherein the block corresponds to a frame.

24. The information recording apparatus according to claim 13, wherein the defect is a scratch, dirt, or dusts on or in the recording medium.

25. A disc drive comprising an information recording apparatus,
said information recording apparatus comprising:
an obtaining device for obtaining information;
a recording device for recording the information obtained by said obtaining device onto a recording medium;
a control device for controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device;
a defect detecting device for detecting a defect on the recording medium on the basis of the control signal; and
a list making device for making or updating a list for indicating a position of the defect from a detection result by said defect detecting device.

26. A disc drive comprising an information reading apparatus, said information reading apparatus comprising:
a reading device for reading information recorded on a recording medium;
a decoding device for decoding the information read by said reading device;
a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device;
a defect detecting device for detecting a defect on the recording medium on the basis of the control signal; and
a list making device for making or updating a list for indicating a position of the defect from a detection result by said defect detecting device.

27. A computer program product in a computer-readable medium for tangibly embodying a program of instructions executable by a computer to make the computer function as an information recording apparatus,
said information recording apparatus comprising:
an obtaining device for obtaining information;
a recording device for recording the information obtained by said obtaining device onto a recording medium;
a control device for controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device;
a defect detecting device for detecting a defect on the recording medium on the basis of the control signal; and
a list making device for making or updating a list for indicating a position of the defect from a detection result by said defect detecting device.

28. A computer program product in a computer-readable medium for tangibly embodying a program of instructions executable by a computer to make the computer function as an information reading apparatus,
said information reading apparatus comprising:
a reading device for reading information recorded on a recording medium;
a decoding device for decoding the information read by said reading device;
a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device;
a defect detecting device for detecting a defect on the recording medium on the basis of the control signal; and
a list making device for making or updating a list for indicating a position of the defect from a detection result by said defect detecting device.

29. An information recording method comprising:
an obtaining process of obtaining information;
a recording process of recording the information obtained by said obtaining process onto a recording medium by a recording device;
a control process of controlling (i) a positional relationship between said recording device and the recording medium or (ii) a recording operation of said recording device, on the basis of a control signal which changes according to (I) the positional relationship between said recording device and the recording medium or (II) the state of the recording operation of said recording device;
a defect detecting process of detecting a defect on the recording medium on the basis of the control signal; and
a list making device for making or updating a list for indicating a position of the defect from a detection result by said defect detecting process.

30. An information reading method comprising:
a reading process of reading information recorded on a recording medium by a reading device;
a decoding process of decoding the information read by said reading process;
a control device for controlling (i) a positional relationship between said reading device and the recording medium or (ii) the reading operation of said reading device, on the basis of a control signal which changes according to (I) the positional relationship between said reading device and the recording medium or (II) the state of the reading operation of said reading device;
a defect detecting process of detecting a defect on the recording medium on the basis of the control signal; and
a list making device for making or updating a list for indicating a position of the defect from a detection result by said defect detecting process.
